(19) United States
(12) Patent Application Publication
(10) Pub. No.: US 2026/0081140 A1
(43) Pub. Date: Mar. 19, 2026

(54) METHODS OF PREPARING ELECTRODES AND ELECTROCHEMICAL DEVICES CONTAINING THE ELECTRODE

(71) Applicant: Factorial Inc., Billerica, MA (US)

(72) Inventors: Jia Du, Burlington, MA (US); Dong Ren, Woburn, MA (US); Wenhan Niu, North Reading, MA (US); Michael McHale, Somerville, MA (US)

(21) Appl. No.: 19/289,562

(22) Filed: Aug. 4, 2025

Related U.S. Application Data
(63) Continuation-in-part of application No. PCT/US24/35232, filed on Jun. 24, 2024.
(60) Provisional application No. 63/511,266, filed on Jun. 30, 2023.

(51) Int. Cl. H01M 4/36; H01M 4/02; H01M 4/04; H01M 4/58; H01M 4/62; H01M 10/0569

(52) U.S. Cl. CPC H01M 4/364; H01M 4/0435; H01M 4/0471; H01M 4/58; H01M 4/623; H01M 4/625; H01M 10/0569; H01M 2004/021

(57) ABSTRACT

Provided herein are methods of preparing electrodes. The method comprises: combining an electroactive material, an electron conductive material, an electrolyte, and a polymeric binder, to form an active mixture; and shaping the active mixture to form an electrode. In some embodiments, the electrolyte comprises a salt and a nonaqueous solvent of the salt. In some embodiments, the solvent of the salt does not dissolve the polymeric binder. In some embodiments, the method does not include a drying step to remove the solvent and the nonaqueous solvent remains in the active mixture and the electrode. In some embodiments, the electrode as prepared has an areal capacity of at least 2 mAh/cm² and a thickness of at least 30 μm.

### CROSS-REFERENCE

The present application is a continuation-in-part application of PCT application No. PCT/US24/35232, filed Jun. 24, 2024, which claims the benefit of U.S. Ser. No. 63/511,266, filed Jun. 30, 2023, the entire content of which is incorporated herein by reference into this application.

### TECHNICAL FIELD

This disclosure relates to methods of preparing electrodes and electrochemical devices such as batteries, capacitors, sensors, condensers, electrochromic elements, and photoelectric conversion elements containing the electrodes.

### BACKGROUND

Electrodes can be prepared by a slurry method which usually involves a certain amount of solvent, or a dry film making method (solvent-free method) in which electroactive materials, electric conductive material, and a polymeric binder are mixed. Typically, organic solvents such as N-methyl-2-pyrrolidone (NMP) with a weight percentage of around 30% are used in a slurry method to provide certain flowability. Due to the existence of a large amount of solvent, other components such as electrolyte salts and surface modifiers can be feasibly added into the slurry. However, such solvent must be removed by a dry step after the slurry is applied to a substrate and does not eventually form a part of the final electrode. Furthermore, the slurry method is usually less capable of forming a thick electrode.

On the other hand, a dry film making method usually includes powder compression, vapor deposition, powder spray, binder fibrillation, and melt stretching. As no solvent is used, dry film making methods are usually more cost-effective, more environmentally friendly and more capable of forming an electrode with a high thickness and uniform distribution. However, the exclusion of liquid component in dry film making methods has some disadvantages. For example, the electrodes prepared by a dry film making method may exhibit a less desirable wettability and electrolytes may require a longer soaking time so that the pores of the electrode are pre-filled or filled with electrolytes. To modify the surface wettability in an efficient and homogeneous way, a modifying agent in a liquid form is usually needed. Since a dry film making method is typically solvent free, it is challenging to modify the surface by incorporating a solid surface modifier into a mixture of solid components. Thus, there remains a need for a new method of preparing electrodes in addressing the challenge above.

### SUMMARY

The present disclosure generally relates to various methods of preparing an electrode and electrochemical devices thereof. The subject matter of the present disclosure involves, in some cases, interrelated products, alternative solutions to a particular problem, and/or a plurality of different uses of one or more systems and/or articles.

Provided herein are methods of preparing an electrode. The method comprises: combining electroactive material, an electron conductive material, a polymeric binder and an electrolyte to form an active mixture; and shaping the active mixture to form an electrode. In some embodiments, the electrolyte comprises a salt and a nonaqueous solvent.

Also provided herein are electrochemical devices comprising the electrodes as prepared by the methods disclosed herein.

Conventionally, an electrode is prepared with no electrolyte and requires a long soaking time so that the components in electrolyte such as salt and solvent can fully infiltrate electrode's surface and porous structure. An electrode prepared by the method as described herein can have a reduced soaking time because the electrolyte is added into the active mixture in advance, which can facilitate and accelerate the infiltration. In addition, the methods disclosed herein can reduce the environmental impact and/or improve the safety of the electrode by reducing the amount of or being substantially free of hazardous solvents such as N-methyl-2-pyrrolidone (NMP), dimethylformamide (DMF), dimethylacetamide (DMAc), and dimethylsulfoxide (DMSO).

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF THE DRAWINGS

Non-limiting embodiments of the present disclosure will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure.

FIG. 1 is a graph of voltage versus specific capacity of various batteries as described herein with differing electrode thicknesses.

FIG. 2 is a graph of specific capacity versus C-rate of various batteries as described herein with differing electrode thicknesses.

FIG. 3 is a graph of voltage versus specific capacity of a battery described herein.

FIG. 4 is a graph of voltage versus specific capacity of a battery with an electrode formed according to the disclosure and a battery with a comparative electrode.

### DETAILED DESCRIPTION

The present disclosure generally relates to methods of preparing an electrode suitable for various electrochemical devices. In some embodiments, the method of preparing an electrode comprises combining an electroactive material, an electron conductive material (alternatively electronically conductive material), a polymeric binder, and an electrolyte to form an active mixture, and shaping the active mixture to form an electrode. In some embodiments, the electrolyte comprises a salt and a nonaqueous solvent that dissolves the salt.

The term “% by weight” or “wt %” refers to the components represented with the percent calculated as percent by weight of all components, unless otherwise specified.

As used herein, “about” means±20% of the stated value, and includes more specifically values of ±10%, ±5%, ±2% and ±1% of the stated value.

As used herein, the term “substantially free of” an ingredient(s) is intended to mean that the mixture or material(s) contain less than about 0.1 wt % (percent by weight of the total weight of the mixture or material(s)), or insignificant or negligible amounts of said ingredient(s) unless specified otherwise.

Preparing an electrode can include combining an electroactive material, such as cathode active material (CAM), an electron conductive material, a polymeric binder and an electrolyte to form an active mixture. Combining the electroactive material, the electron conductive material, the polymeric binder and the electrolyte to form an active mixture may be achieved by blending. The blending can last for a length of time of about 10 seconds to about 10 hours (e.g., about 10 seconds to about 1 hour, or about 10 seconds to about 30 minutes, about 10 seconds to about 10 minutes, or about 10 seconds to about 1 minute). A blending may include multiple cycles. Each cycle can last for a length of time. In some embodiments, there is a pause from about 5 seconds to 5 minutes between adjacent cycles.

Combining an electroactive material, an electron conductive material, apolymeric binder and an electrolyte to form an active mixture can include blending the first three components to form an intermediate mixture. The intermediate mixture is then blended with the electrolyte to form the active mixture. Blending the first three components can be repeated at least once. In some embodiments, blending the intermediate mixture with the electrolyte is repeated at least once. In some embodiments, a blending step may include multiple cycles. In some embodiments, each cycle lasts for a length of time of about 10 seconds to about 10 hours (e.g., about 10 seconds to about 1 hour, or about 10 seconds to about 30 minutes, about 10 seconds to about 10 minutes, or about 10 seconds to about 1 minute).

In some embodiments, an electroactive material, an electron conductive material, a polymeric binder and an electrolyte are combined into the active mixture by blending and/or mixing via a one-step procedure. In some embodiments, they are combined into an active mixture by two steps, i.e., a first step which blends them into a first mixture and a second step which further mixes the first mixture typically with a relatively high shear force to achieve a desired uniformity. In some embodiments, the first step is conducted at room temperature. In some embodiments, the second step is performed at an elevated temperature. In some embodiments, the shear force in the second step is generated by grinding the first mixture in a heated container such as mortar, rolling on a set of heated rollers, or both. In some embodiments, the second step is part of the shaping step, which is usually conducted on rollers. In some embodiments, the elevated temperature is sufficiently high to soften the polymeric binder and lower than the melting point of the polymeric binder. In some embodiments, the elevated temperature is lower than the boiling point of the solvent in the electrolyte. In some embodiments, the elevated temperature is in a range from 30° C. to 150° C.

In some embodiments, the nonaqueous solvent in the electrolyte is the only solvent. In some embodiments, the nonaqueous solvent dissolves the salt in the electrolyte and does not dissolve the polymeric binder. In some embodiments, the blending is performed in the absence of polymeric binder solvents such as N-methyl-2-pyrrolidone (NMP), dimethylformamide (DMF), dimethylacetamide (DMAc), and dimethylsulfoxide (DMSO). In some embodiments, the active mixture and the electrode are substantially free of NMP, DMF, DMAc, and DMSO.

Preparing the electrodes can include heating the active mixture prior to and/or during the shaping of the active mixture to form an electrode. In some embodiments, heating the active mixture occurs during the shaping of the active mixture. In some embodiments, heating the active mixture occurs prior to the shaping of the active mixture. In some embodiments, heating the active mixture comprises grinding the active mixture. In some embodiments, grinding occurs via a grinder, a mortar and pestle, or the like

Preparing the electrodes can include shaping the active mixture to form an electrode. Shaping the active mixture to form an electrode can include flattening the active mixture into an electrode in the shape of a film. In some embodiments, shaping can include calendaring the active mixture. In some embodiments, shaping can include extruding the active mixture. Shaping the active mixture can be repeated at least once, twice, or three times.

Heating the active mixture can occur at a temperature in a range from about 30° C. to about 150° C. For example, heating the active mixture occurs at a temperature in a range from about 30° C. to about 100° C., from about 40° C. to about 90° C., from about 50° C. to about 100° C., from about 60° C. to about 85° C., or from about 70° C. to about 90° C. In some embodiments, heating the active mixture occurs at a temperature in a range from about 70° C. to about 95° C. In some embodiments, the active mixture as formed is in a dough-like form. In some embodiments, the active mixture is ready for a subsequent shaping step. In some embodiments, the shaping step includes rolling or compressing.

Preparing an electrode can further include a lamination step, i.e., laminating the electrode onto a current collector. In some embodiments, the lamination is performed on heated rollers. In some embodiments, the heated rollers are maintained at a temperature in a range from about 50° C. to about 100° C.

The electron conductive material may include a conductive carbon. In some embodiments, the electron conductive material is an electron conductive carbon. The electron conductive carbon can include one or more selected from the group consisting of carbon black, carbon nanotubes, graphite, artificial graphite, graphene and carbon fiber. In some embodiments, the electron conductive carbon includes carbon black. In some embodiments, the electron conductive carbon is carbon black. In some embodiments, the electron conductive carbon includes graphene. In some embodiments, the electron conductive carbon is graphene. In some embodiments, the electron conductive carbon includes carbon nanotubes. In some embodiments, the electron conductive carbon is carbon nanotubes. In some embodiments, the electron conductive carbon includes carbon fiber. In some embodiments, the electron conductive carbon is carbon fiber. In some embodiments, the carbon fiber is a vapor grown carbon fiber.

The electron conductive material can be present in an amount in a range from about 0.1 wt % to about 10 wt %, based on the total weight of the electrode. In some embodiments, the electron conductive material is present in an amount in a range from about 0.5 wt % to about 5 wt %, from about 0.5 wt % to about 3.5 wt %, or from about 1.5 wt % to about 3.5 wt %, based on the total weight of the electrode). In some embodiments, the electron conductive material is present in an amount in a range from about 0.5 wt % to about 2.5 wt %, based on the total weight of the electrode.

In some embodiments, the polymeric binder is a fibrillizable binder. The fibrillizable binder can be fibrillized during process to provide fibrils, thus providing mechanical support to components within the electrode film. In some embodiments, the fibrillizable binder includes, without limitation, polytetrafluoroethylene (PTFE), ultra-high molecular weight polyethylene (UHMWPE), and a combination thereof. In some embodiments, a dry fibrillizable binder is combined with the electron conductive material, the electrolyte, and the electroactive material to form the active mixture. In some embodiments, the polymeric binder includes a non-crosslinked polymer. In some embodiments, the polymeric binder includes a non-crosslinked polymer and a crosslinked polymer.

The polymeric binder can include a fluorinated polymer. In some embodiments, the non-crosslinked polymer includes a fluorinated polymer. In some embodiments, the fluorinated polymer includes at least one selected from the group consisting of polytetrafluoroethylene (PTFE), polyvinylidene fluoride (PVDF), poly(vinylidene fluoride-co-hexafluoropropylene) (PVDF-HFP), polyvinylfluoride (PVF), perfluoroalkoxy polymer (PFA), fluorinated ethylene-propylene (FEP), and perfluoropolyene (PFPE). In some embodiments, the polymeric binder includes polytetrafluoroethylene (PTFE). In some embodiments, the polymeric binder includes polyvinylidene fluoride (PVDF).

The crosslinked polymer can have a heterogeneous polymer network obtained from a crosslinking reaction of a composition that includes one or more crosslinkers. In some embodiments, the crosslinked polymer is synthesized from one or more crosslinkers, wherein at least one of the crosslinkers has three or more polymerizable or crosslinkable terminals. In some embodiments, at least one of the one or more crosslinkers has three or more polymerizable or crosslinkable terminals.

A crosslinker with three or more polymerizable or crosslinkable terminals can be represented as follows:

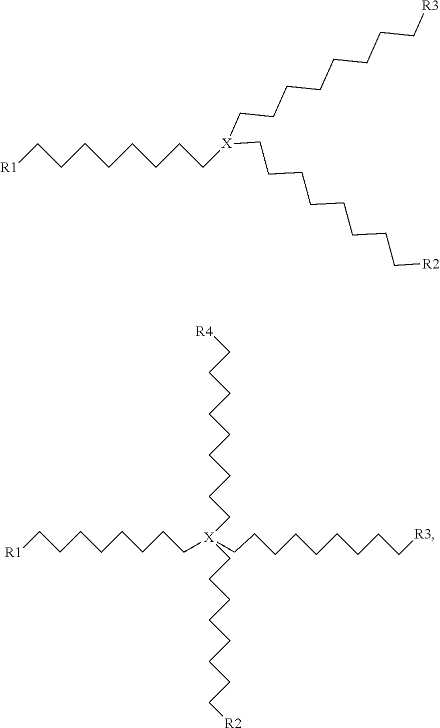

where X is C, Si, N, P, B, or a cyclic ring,
R1, R2, and R3 are polymerizable or crosslinkable terminals covalently connected to X directly or through spacer chain or group. R1, R2, R3 and their spacer chains or groups may be same or different from each other.

In certain embodiments, the three or more polymerizable or crosslinkable terminals (R1, R2, R3 and R4) are independently selected from C₂₋₂₀ alkenyl, C₂₋₂₀ alkynyl, epoxy, amino, hydroxyl, carboxylic acid, or any substituted form thereof.

In certain embodiments, the crosslinker with three or more polymerizable or crosslinkable terminals is a tri-acrylate, tetra-acrylate, modified tri-acrylate, modified tetra-acrylate, silane, siloxane or triazinane-trione (triazine-trione).

In certain embodiments, the crosslinker with three or more terminals has a structural formula selected from:

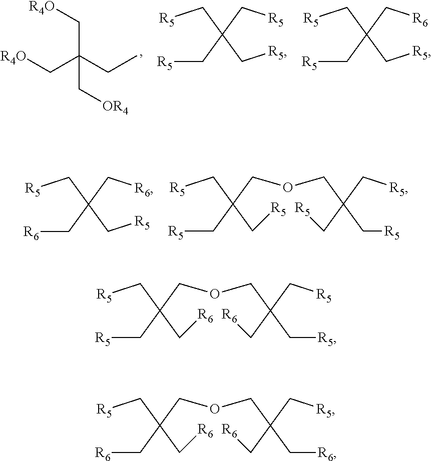

where R₄ and R₅ are independently selected from:

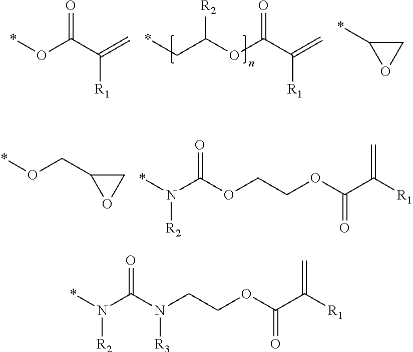

where R₁, R₂, R₃, R₆ are each independently selected from hydrogen, methyl, ethyl, phenyl, methylphenyl, benzyl, acryl, epoxy ethyl, isocyanate, cyclic carbonate, lactone, lactam, and vinyl; n is an integer between 0 and 50,000 and * indicates a point of attachment.

In certain embodiments, the crosslinker is a structural formula selected from:

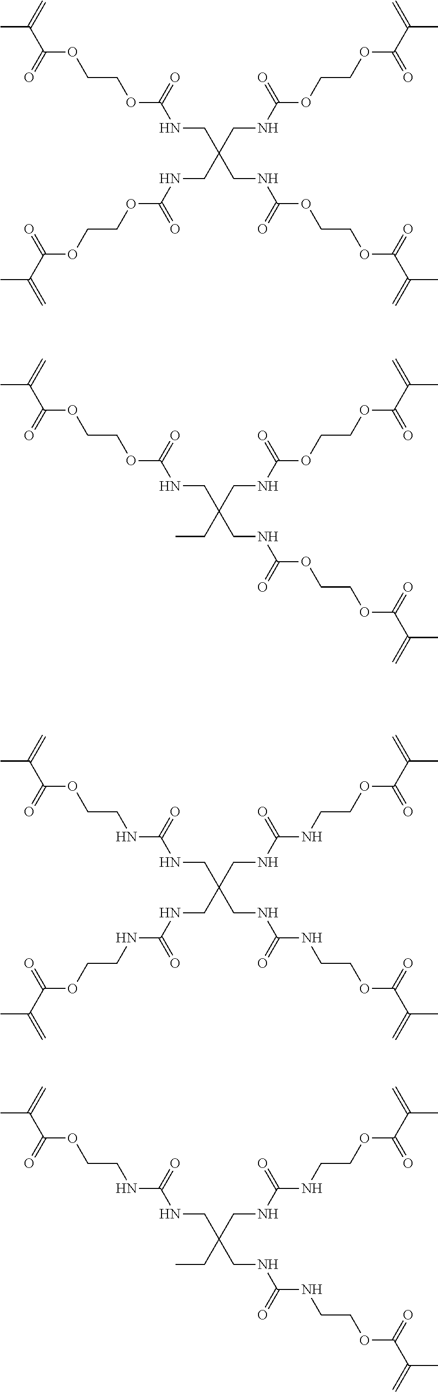

In certain embodiments, tri-acrylates and tetra-acrylates are modified tri-acrylates and tetra-acrylates. In some embodiments, the modified tri-acrylates and tetra-acrylates include substituents such as —CN, —SO₂H, —CO₂H, —CO₂—, F, Cl, Br, or I.

In certain embodiments, the crosslinker with three or more terminals is a silane or siloxane.

In some embodiments, one or more of the crosslinkers or the spacer chains or groups contain a structure including, but not limited to, —O—, —NR^{c}—, —S—, —C(═O)—, —C(═O)O—, —C(═O)NR^{c}—, —C(═O)S—, —OC(═O)O—, —NR^{c}C(═O)O—, —NR^{c}C(═O)NR^{c}—, —S(═O)—, —S(═O)₂—, —OS(═O)₂—, —OS(═O)₂O—, —NR^{c}S(═O)₂—, —NR^{c}S(═O)₂NR^{c}—, —OS(═O)₂NR^{c}—, C₁₋₆ alkylenyl, C₂₋₆ alkenylenyl, C₂₋₆ alkynylenyl, C₆₋₁₄ arylenyl, 5- to 14-membered heteroarylenyl, C₃₋₁₀ carbocyclenyl, or 3- to 10-membered heterocyclenyl, wherein the alkylenyl, alkenylenyl, alkynylenyl, arylenyl, heteroarylenyl, carbocyclenyl, or heterocyclenyl is optionally substituted with halogen, —CN, —NO₂, C₁₋₆ alkyl, C₁₋₆ haloalkyl, C₁₋₆ hydroxyalkyl, C₁₋₆ aminoalkyl, C₂₋₆ alkenyl, C₂₋₆ alkynyl, C₆₋₁₄ aryl, 5- to 14-membered heteroaryl, C₃₋₁₀ carbocyclyl, 3- to 10-membered heterocyclyl, —SR^{b}, —S(═O)R^{a}, —S(═O)₂R^{a}, —S(═O)₂OR^{b}, —S(═O)₂NR^{c}R^{d}, —NR^{c}R^{d}, —NR^{c}S(═O)₂R^{c}R^{d}, —NR^{c}S(═O)₂R^{a}, —NR^{c} S(—O)₂OR^{b}, —NR^{c}S(═O)₂NR^{c}R^{d}, —NRDC(═O)NR^{c}R^{d}, —NRDC(═O)R^{a}, —NRDC(═O) OR^{b}, —OR^{b}, —OS(═O)₂R^{a}, —OS(═O)₂OR^{b}, —OS(═O)₂NR^{c}R^{d}, —OC(═O)R^{a}, —OC(═O) OR^{b}, —OC(═O)NR^{c}R^{d}, —C(═O)R^{a}, —C(═O) OR^{b}, or —C(═O)NR^{c}R^{d}; wherein R^{a}, R^{b}, R^{c}, and R^{d} are independently C₁₋₆ alkyl, C₁₋₆ haloalkyl, C₁₋₆ hydroxyalkyl, C₁₋₆ aminoalkyl, C₂₋₆ alkenyl, C₂₋₆ alkynyl, C₃₋₁₀ carbocyclyl, 3- to 10-membered heterocyclyl, C₆₋₁₄ aryl, or 5- to 14-membered heteroaryl, wherein the alkyl, haloalkyl, hydroxyalkyl, aminoalkyl, alkenyl, alkynyl, carbocyclyl, heterocyclyl, aryl, and heteroaryl is optionally substituted with one or more oxo, halogen, —CN, —OH, —OMe, —NH₂, —C(═O)Me, —C(═O)OH, —C(═O)OMe, C₁₋₆ alkyl, or C₁₋₆ haloalkyl.

In some embodiments, R^{c} and R^{d}, together with the heteroatom (such as N, O, S, P), form a 3- to 10-membered heterocyclyl, where the heterocyclyl is optionally substituted with one or more oxo, halogen, —CN, —OH, —OMe, —NH₂, —C(═O)Me, —C(═O)OH, —C(═O)OMe, C₁₋₆ alkyl, or C₁₋₆ haloalkyl.

In certain embodiments, one of the crosslinkers or the spacer chains or groups include a structure of —XC(═O)CR³—C(R⁴)₂, where X is independently O or NR^{e}, where R^{e} is independently H or C₁₋₆ alkyl, and each R³ and R⁴ is independently H or C₁₋₆ alkyl.

In certain embodiments, one of the crosslinkers is selected from:

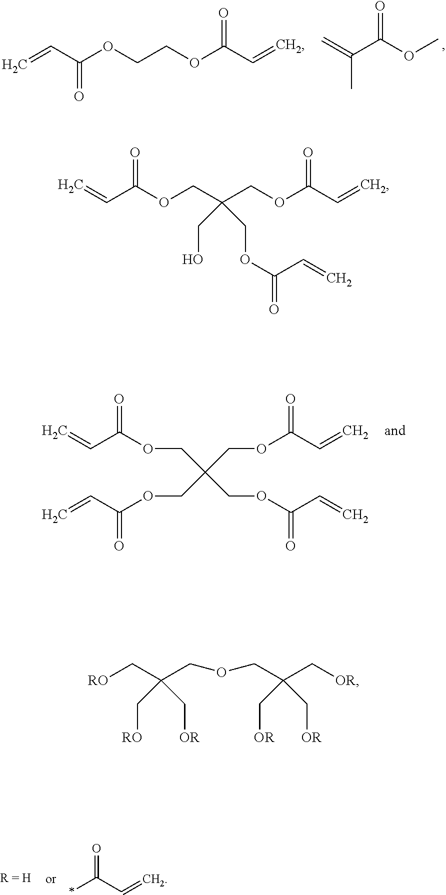

In some embodiments, the crosslinker includes one or more functional groups selected from:

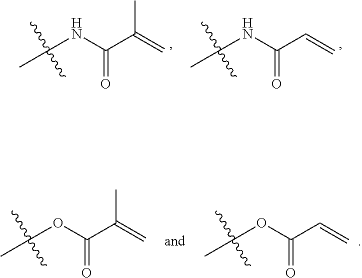

In some embodiments, the crosslinker is a monomer for ring opening polymerization. In some embodiments, the crosslinker is a monomer for ring opening polymerization and can be represented as follows:

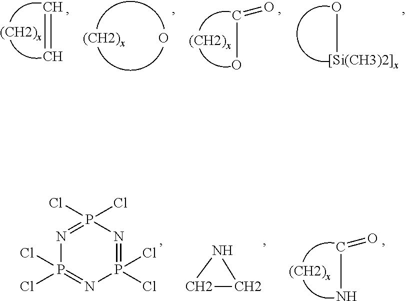

and any substituted form thereof, where x is an integer ranging from 1 to 1000.

In some embodiments, the monomer for ring opening polymerization includes:

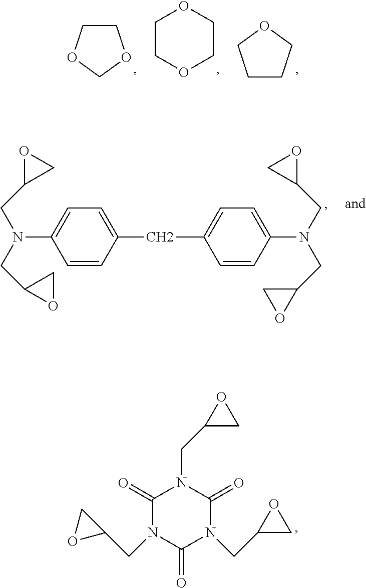

In some embodiments, the monomer for ring opening polymerization comprises an unsubstituted or substituted oxirane ring, oxetane ring, furan ring, aziridine ring, and azetidine ring.

As described herein, some compositions can be used with polymer solid electrolytes, batteries, or other electrochemical devices including same, and methods for producing same. In some cases, the incorporation of vinyl and/or allyl functional groups with UV crosslinking or thermal crosslinking can be used to improve various electrochemical performance, especially when the crosslinker has polymerizable or crosslinkable terminals, such as vinyl and allyl, in at least three directions of the chemical structure of the crosslinker (i.e., the crosslinker has three crosslinkable terminals), the electrochemical performance can be improved more obviously.

In one aspect, the present disclosure is generally directed to an electrochemical cell, such as a battery, including an electrode as disclosed herein. In certain embodiments, the battery is an LIB, such as a lithium-ion solid-state battery. The electrochemical cell may include an anode, a cathode, and/or a separator. Many of these are available commercially. In some embodiments, the electrode may be used as the electrolyte of the electrochemical cell, alone or in combination with other electrolyte materials.

Polymerizable and crosslinkable terminals (alternatively groups) can include without limitation C₂₋₂₀ alkenyl, C₂₋₂₀ alkynyl, epoxy, amino, hydroxyl, carboxylic acid, or any substituted form thereof. In certain embodiment, they are vinyl and/or allyl.

In some embodiments, the terminals or groups, such as vinyl and/or allyl, can be crosslinked together. For example, such functional groups can be crosslinked using UV light, at an elevated temperature (e.g., between 20° C. and 100° C.), in the presence of an initiator, or other methods including those described herein. In some cases, the incorporation of three crosslinkable terminals leads to a disorganized or disordered network, resulting in improved electrochemical performances, or the like, such as relatively high ionic conductivities and decomposition voltages.

The polymeric binder can be present in an amount in a range from about 0.1 wt % to about 10 wt % based on the total weight of the electrode. In some embodiments, the polymeric binder can be present in an amount in a range from about 0.1 wt % to about 3 wt %, from about 0.5 wt % to about 5 wt %, or from about 0.5 wt % to about 2.5 wt %, based on the total weight of the electrode. In some embodiments, the polymeric binder is present in an amount in a range from about 1.5 wt % to about 3.5 wt % based on the total weight of the electrode.

The electrolyte can include a salt (e.g., a lithium salt). The electrolyte can include, for example, a lithium salt, or other salts such as sodium, potassium, magnesium, calcium salts, and the like.

In some embodiments, the electrolyte includes a lithium salt. In some embodiments, the electrolyte includes at least one selected from the group consisting of lithium perchlorate (LiClO₄), lithium hexafluorophosphate (LiPF₆), lithiumborofluoride (LiBF₄), lithium hexafluoroarsenide (LiAsF₆), lithium trifluoro-metasulfonate (LiCF₃SO₃), bis-trifluorom-ethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphates (LiPF₃(CF₂CF₃)₃), lithium bisperfluoro-ethysulfo-nylimide (LiBETI), lithium bis(trifluoromethanesulphonyl)imide, lithium bis(fuorosulphonyl)imide, lithium trifluoromethanesulfonimide (LiTFSI), lithium bis(fluorosulfonyl)imide (LiFSI), lithium difluoro(oxalato)borate (LiDFOB), lithium perchlorate (LiClO₄), LiC(CF₃SO₂)₃, LiF, LiCl, LiBr, LiI, Li₂SO₄, LiNO₃, Li₃PO₄, Li₂CO₃, lithium acetate, lithium trifluoromethyl acetate, and lithium oxalate. For example, the electrolyte includes LiFSI, LiTFSI or both. In some embodiments the electrolyte comprises LiFSI.

The electrolyte can include a nonaqueous solvent and an electrolyte salt such as lithium salt. In some embodiments, the electrolyte includes a lithium salt and a nonaqueous solvent of the lithium salt. In some embodiments, the nonaqueous solvent (e.g., the electrolyte solvent) includes one or more of 1,2-diethoxyethane, 1,1-diethoxyethane, 1,1-dipropoxy-ethane, 1,2-dipropoxy-ethane, diethylene glycol, 2-(2-ethoxyethoxy) ethanol, diethylene glycol dimethyl ether, diethylene glycol diethyl ether, diethylene glycol dibutyl ether, triethylene glycol, tri (ethylene glycol) monomethyl ether, tri (ethylene glycol) monoethyl ether, tri (ethylene glycol) monobutyl ether, triethylene glycol dimethyl ether, triethylene glycol diethyl ether, diethylene glycol dibutyl ether, tetraethylene glycol, tetra(ethylene glycol) monomethyl ether, tetra(ethylene glycol) monoethyl ether, tetra(ethylene glycol) monobutyl ether, tetraethylene glycol dimethyl ether, tetraethylene glycol diethyl ether, tetraethylene glycol dibutyl ether, ethylene carbonate, diethylene carbonate, dimethyl carbonate, ethyl methyl carbonate, propylene carbonate, fluoroethylene carbonate, vinylene carbonate, succinonitrile, succinonitrile, glutaronitrile, hexonitrile, malononitrile, dimethyl sulfoxide, prop-1-ene-1,3-sultone, sulfolane, ethyl vinyl sulfone, tetramethylene sulfone, vinyl sulfone, methyl vinyl sulfone, phenyl vinyl sulfone, N-propyl-N-methylpyrrolidinium bis(fluorosulfonyl)imide, 1-ethyl-3-methylimidazolium bis(fluorosulfonyl)imide, trimethyl phosphate, triethyl phosphate, and poly(ethylene oxide).

In some embodiments, the nonaqueous solvent dissolves the salt (e.g., the lithium salt) but does not dissolve the polymeric binder. In some embodiments, the nonaqueous solvent does not dissolve the fibrillizable polymer binder. The nonaqueous solvent can be used to dissolve or otherwise facilitate the mixing or distribution of the electrolyte salts in the active mixture. The amount of the electrolyte solvent used can depend on multiple factors, such as its interaction with other components. The specific amount of a nonaqueous solvent may vary from case to case. In general, the minimum amount of a nonaqueous solvent would allow the electrolyte salts uniformly distributed within the active mixture and enable the final electrode exhibiting a desired wettability.

A maximum amount of a nonaqueous solvent would keep the active mixture as a dough rather than a slurry so that it can be subsequently proceeded by calendaring. In some cases, because the nonaqueous solvent is not removed from the active mixture, the maximum amount of the electrolyte solvent should not be higher than a threshold value that deteriorates the processability or overall electrochemical performance of the battery. In some embodiments, the nonaqueous solvent is present in an amount no higher than 5.0 wt %, no higher than 5.5 wt %, no higher than 6.0 wt %, no higher than 6.5 wt %, no higher than 7.0 wt %, no higher than 7.5 wt %, no higher than 8.0 wt %, no higher than 8.5 wt % or no higher than 9.0 wt % based on the total weight of the active mixture or electrode.

A salt can be present in an amount in a range from about 5 wt % to about 75 wt % based on total weight of the electrolyte. In some embodiments, a salt can be present in an amount in a range from about 15 wt % to about 75 wt %, from about 25 wt % to about 75 wt %, from about 30 wt % to about 70 wt %, from about 40 wt % to about 60 wt %, or from about 15 wt % to about 50 wt %, based on the total weight of the electrolyte.

A salt in the electrolyte, such as lithium salt, can be present in an amount of in a range from about 5 wt % to about 75 wt % based on total weight of the electrolyte, i.e., total weight of the salt and the nonaqueous solvent. In some embodiments, a salt can be present in an amount in a range from about 15 wt % to about 75 wt %, from about 25 wt % to about 75 wt %, from about 30 wt % to about 70 wt %, from about 40 wt % to about 60 wt %, or from about 15 wt % to about 50 wt %, based on the total weight of the electrolyte.

An electrolyte can be present in an amount in a range from about 1 wt % to about 30 wt % based on the total weight of the active mixture or electrode. In some embodiments, an electrolyte can be present in an amount in a range from about 5 wt % to about 25 wt %, from about 10 wt % to about 30 wt %, from about 10 wt % to about 20 wt %, or from about 1 wt % to about 10 wt % based on the total weight of the active mixture or electrode. In some embodiments, the electrolyte is present in an amount in a range from about 5 wt % to about 15 wt % based on the total weight of the active mixture or electrode.

In some embodiments, the nonaqueous solvent for the electrolyte may be an ionic liquid. In some embodiments, the cations of the ionic liquid may be, for example, organic nitrogen cation. Non-limiting examples of suitable cations include 1-ethyl-3-methylimidazolium (Im12⁺), (N,N-diethyl-N-methyl-N(2methyoxyethyl)ammonium, 1,3-dimethylimidazolium, 1-(4-sulfobutyl)-3-methylimidazolium, 1-butyl-1-methylpyrrolidinium, 1-butyl-3-methylimidazolium, 1-hexyl-3-methylimidazolium, 1-methyl-1-(2-methoxyethyl) pyrrolidinium, 1-methyl-1-octylpyrrolidinium, 3-methyl-1-propylimidazolium, N,N-diethyl-N-methyl-N-propylammonium, N-butyl-N-methylpiperidinium, N-propyl-N-methylpiperidinium, 1-ethyl-3-methylimidazolium (EMI), 1-Butyl-3-methylimidazolium (BMI), 1-Octyl-3-methylimidazolium (C8MI), 1-decyl-3-methylimidazolium (C10MI), 1-methyl-3-[2,6-(S)-dimethylocten-2-yl]imidazolium (MDI), 1,2-dimethyl-3-ethylimidazolium (M1,2E3I), 1,2-dimethyl-3-propylimidazolium (DMPI), N-methyl-N-propyl-pyrrolidinium (P13), N-methyl-N-butyl-pyrrolidinium (P14), imidazolium, pyrrolidinium, quaternary ammonium, alicyclic cation, pyrrolidine cation, iminazole cation, ethylmethylimidazolium cation, and quaternary ammonium cation.

Anions of ionic liquids can be important in lithium battery applications. Non-limiting examples of suitable anions of the ionic liquid include Cl⁻, bis(fluorosulfonyl)imide (FSI⁻), BF₄⁻, difluoro(oxalato)borate (DFOB⁻), N, N-bis(trifluoromethane) sulphonamide (TFSI⁻), bisperfluoroethylsulfonyl imide (BETI), bis(methanesulfonyl)imide (MSI), trifluoromethanesulfonate (OTf), Trifluoroacetate (TA), hexafluorophosphate ((PF₆⁻)₃), CF₃SO₃⁻, [(CF₃SO₂)₂N]⁻, [(FSO₂)₂N]⁻, [(CF₃SO₂)₂N]⁻, bis(trifluoromethanesulfonyl)imide (TFSI⁻), iodide, methyl-phosphate, trifluoromethanesulfonate, bis(oxalate)borate (BOB⁻), acetate, dicyanamide, diethyl phosphate, and hexafluorophosphate. In some cases, the anion includes organic anions. In some cases, the anion includes a ‘plasticizing anion’ which is an anion having a delocalized charge and multiple conformations differing only marginally in energy.

Various kinds of ionic liquids can be used as the solvent for the electrolyte salt in the active mixture. The ionic liquid has a melting point of, for example, less than 100° C. Non-limiting examples of suitable ionic liquid include N-methyl-N-propylpyrrolidinium bis(fluorosulfonyl)imide ionic liquid, N-alkyl-N-methylpyrrolidinium, perfluorosulfonylimide (PFSI), N-alkyl-N-methylpyrrolidinium (PYR1A) perfluorosulfonylimide (PFSI), 1-ethyl-3-methylimidazolium bis(fluorosulfonyl)imide (IM12FSI), 1-propyl-3-methylimidazolium bis(fluorosulfonyl)imide (IM13FSI), N-butyl-N-methyl-pyrrolidinium bis(trifluoromethanesulfonyl)imide (Py14TFSI), N-methyl-N-propyl-pyrrolidinium bis(fluorosulfonyl)imide (Py13FSI), and N-butyl-N-methylpyrrolidinium bis(fluorosulfonyl)imide (Py14FSI).

In some embodiments, when an ionic liquid is used as the electrolyte solvent in the active mixture, the electrolyte salt such as lithium salt may be needed with a relatively smaller amount as the ionic liquid itself is an electrolyte salt and plays a similar rule like lithium salt, for example, in ion conduction.

In some embodiments, the electrolyte solvent remains in the active mixture and the final electrode. In some embodiments, the preparation method does not include a drying step, which is typically required for a traditional slurry method.

The electroactive material can include a lithium metal oxide salt (e.g., lithium oxide salts). In some embodiments, the electroactive material includes one or more of lithium nickel manganese cobalt oxide (NMC), LiCoO₂, lithium manganese oxide (LMO), lithium iron phosphate (LFP), LiMnPO₄, LiCoPO₄, lithium nickel cobalt aluminum oxide, or lithium titanate, and Li₂MMn₃O₈, wherein M is selected from Fe or Co.

The electroactive material can include one or more selected from the group consisting of LiFePO₄, LiₓMO₂, LiₓNi_{1-y-z}Co_{y}M1_{z}O₂ and LiₓNi_{1-y-z}Mn_{y}M2_{z}O₂, wherein M is at least one selected from the group consisting of Ni, Co, Mn, Al, B, Fe, Mg, Ca, Sr, Sc, Y, Ti, Zr, V, Nb, Ta, Cr, Mo, W, Rh, Pd, Cu, Zn, Cd, Ga, In, Sn, and rare earth elements, wherein M1 is one or more selected from the group consisting of Mn, Al, B, Fe, Mg, Ca, Sr, Sc, Y, Ti, Zr, V, Nb, Ta, Cr, Mo, W, Rh, Pd, Cu, Zn, Cd, Ga, In, Sn, and rare earth elements, wherein M2 is one or more selected from the group consisting of Co, Al, B, Fe, Mg, Ca, Sr, Sc, Y, Ti, Zr, V, Nb, Ta, Cr, Mo, W, Rh, Pd, Cu, Zn, Cd, Ga, In, Sn, and rare earth elements, and wherein 0.95≤x≤1.1, 1-y-z>0, 0<y≤0.5, 0≤z≤0.5.

The electroactive material can be present in an amount of about 50 wt % to about 98.8 wt %, based on the total weight of the electrode (e.g., about 60 wt % to about 97 wt %, or about 75 wt % to about 95 wt %, or about 85 wt % to about 98 wt %, or about 50 wt % to about 75 wt %, based on the total weight of the electrode). In some embodiments, the electroactive material is present in an amount of about 85 wt % to about 95 wt %, based on the total weight of the electrode.

Advantageously, the electrode prepared according to the disclosure can have a thickness of about 30 μm to about 200 μm, about 50 μm to about 170 μm, or about 60 μm to about 160 μm, and an areal capacity of about 2 mAh/cm² to about 15 mAh/cm², about 3.5 mAh/cm² to about 15 mAh/cm², about 4 mAh/cm² to about 10 mAh/cm², or about 5.5 mAh/cm² to about 10 mAh/cm². For example, the electrode prepared according to the disclosure has an areal capacity of at least 2 mAh/cm² when the electrode has a thickness of at least 30 μm. For example, the electrode prepared according to the disclosure has an areal capacity of at least 5 mAh/cm² when the electrode has a thickness of at least 80 μm.

Provided herein is an electrochemical device comprising the electrode as prepared by the methods described herein.

The electrochemical device described herein can be anode-free or can include an anode. In some embodiments, the electrochemical device includes an anode.

The anode can be a carbon anode, Li anode, Si anode, Alloy anode, Li₄Ti₅O₁₂, or made from conversion anode materials. In some embodiments, the carbon anode includes graphite, soft carbon, hard carbon, or combinations of thereof. In some embodiments, the Li anode includes Li metal foil, Li metal on Cu, Ni, or stainless steel. In some embodiments, the Si anode includes Si, Si/Carbon composite, SiOₓ (0≤x<2), SiOₓ (0≤x<2)/carbon composite or a combination thereof. In some embodiments, the alloy anode includes Sn, SnO₂, Sb, Al, Mg, Bi, In, As, Zn, Ga, B, or a combination thereof. In some embodiments, the conversion anode materials include MₐX_{b}, M is Mn, Fe, Co, Ni, or Cu, X is O, S, Se, F, N, or P, a and b are respectively 1 to 4. In some embodiments, the anode is Li metal foil or Li metal on Cu, Ni, or stainless steel.

As used herein, the term “Coulombic efficiency” refers to the result of discharge capacity divided by the charge capacity in the same charge and discharge cycle.

In some embodiments, the electrochemical device includes the electrode as prepared according to the disclosure having a thickness of at least 30 μm and has an areal capacity of at least 2 mAh/cm².

In some embodiments, the electrochemical device comprises the electrode as prepared according to the disclosure having a thickness of at least 80 μm and has an areal capacity of at least 5 mAh/cm².

The present disclosure generally relates to a device with the electrodes disclosed herein. The device may be a battery, an LIB or a lithium-ion solid-state battery. The battery may be configured for applications such as, portable applications, transportation applications, stationary energy storage applications, and the like. Non-limiting examples of the ion-conducing batteries include lithium-ion conducting batteries, and the like. The device may also be a battery comprising one or more lithium ions electrochemical cells.

In various examples, a battery includes an electrode as prepared according to the disclosure and an anode.

Some crosslinkers, electrolyte salts, additives and other materials as described in US application publication Nos. 20200144665 A1 and 20200144667 A1 which are incorporated herein by reference in their entirety.

The following examples are intended to illustrate certain embodiments of the present disclosure, but do not exemplify the full scope of the disclosure.

The foregoing description and following examples detail certain specific embodiments as described herein and describe the best mode that the inventors contemplated. It will be appreciated, however, that no matter how detailed the foregoing may appear in text, the disclosure may be practiced in many ways, and the disclosure should be construed in accordance with the appended claims and equivalents thereof.

Although the disclosed teachings have been described with reference to various applications, methods, compounds, compositions, and materials, it will be appreciated that various changes and modifications to them may be made without departing from the teachings herein. The following examples are provided to better illustrate the disclosed teachings and are not intended to limit the scope of the teachings presented herein. While the present teachings have been described in terms of these exemplary embodiments, the skilled artisan will readily understand that numerous variations and modifications of these exemplary embodiments are possible without undue experimentation. All such variations and modifications are within the scope of the teachings of this disclosure.

### EXAMPLES

### Example 1A—Preparation of Electrochemical Devices

### Preparation of Electrode

To a blender 47 g of NMC811 and 1.5 g of vapor grown carbon fiber (VGCF) were added and then blended in three intervals of 30 seconds. To the same blender, 1.5 g of PTFE as polymeric binder was added and then blended for 30 seconds. To the same blender, 5 g of 2.5M LiFSI in a nonaqueous solvent was added and blended for 30 seconds to form the active mixture. 5 g of the active mixture was added to a mortar at 80° C. and the active mixture was ground using a pestle for 10 minutes. The active mixture was then calendared multiple times to obtain a cathode film with desired thickness. The cathode film was laid on a carbon coated aluminum foil (as cathode current collector) and fed through with rollers heated to 90° C. to laminate the film, complete the fabrication and obtain the cathode with the cathode current collector. Each cathode includes the following formulation: 91 wt % of NMC811, VGCF, and PTFE (94 wt % NMC811+3 wt % VGCF+3 wt % PTFE), and 9 wt % 2.5M LiFSI in a nonaqueous solvent. The various cathode thicknesses are shown below in Table 1.

TABLE 1

| | Cathode |
|---|---|
| Cathode | Thickness (μm) |
| A1 | 158 |
| A2 | 141 |
| A3 | 120 |
| A4 | 101 |
| A5 | 79 |
| A6 | 58 |

### Preparation of Coin Cells

TABLE 2

| | | Area | | Specific Discharge |
|---|---|---|---|---|
| | | Loading | | Capacity at C/10 |
| Battery | Cathode | (mAh/cm²) | Porosity | (mAh/g) |
| 1 | A1 | 12.61 | 26% | 205.8 |
| 2 | A2 | 11.42 | 26% | 206.9 |
| 3 | A3 | 9.91 | 24% | 206.5 |
| 4 | A4 | 7.75 | 29% | 204.5 |
| 5 | A5 | 6.55 | 24% | 211.1 |
| 6 | A6 | 5.08 | 22% | 214.5 |

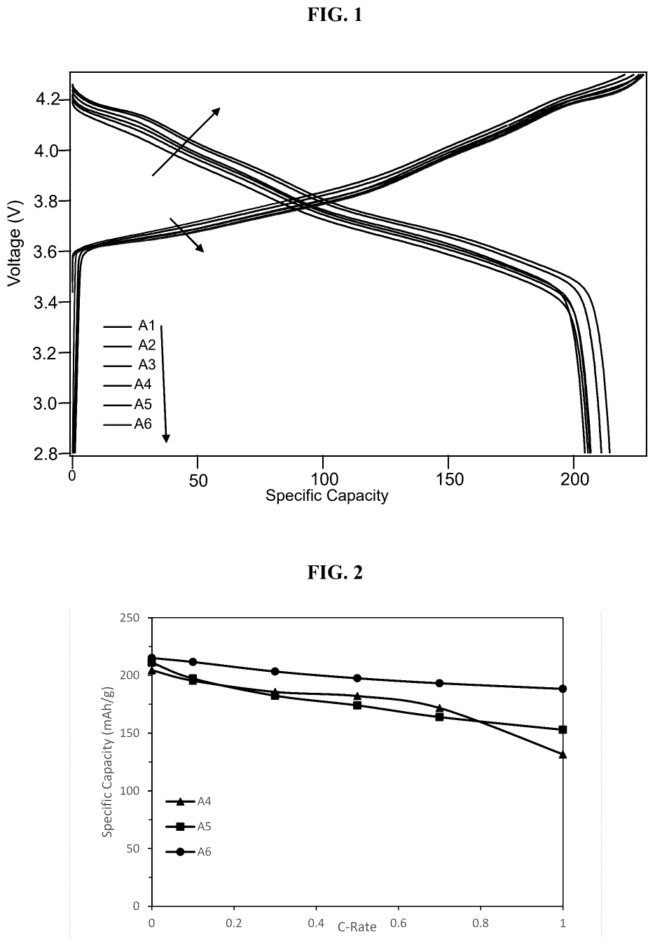

Each cathode A1-A6, independently, was assembled in a 2032-coin cell with Li metal as anode. The cycling test was performed with a Neware cycling tester. All the batteries were tested using the same charging and discharging rate. The charge/discharge voltage window was from 2.8 V to 4.3 V. The battery was charged and discharged at a current rate of 0.1 C at room temperature as formation and areal capacity is calculated based on the total capacity divided by the active area. The coin cells functioned at all thicknesses tested (Table 2 and FIG. 1). In the cycling step, the battery was charged at C/3 and discharged at various C-rates up to 1 C at room temperature. FIG. 2 shows the results of the battery testing and that samples A4 through A6 had suitable discharge capability.

### Example 1B—Preparation of Electrochemical Devices

### Preparation of Electrode

To a blender 47 g of NMC811 and 1.5 g of carbon black (LITX®HP) were added and then blended in three intervals of 30 seconds. To the same blender, 1.5 g of PTFE was added and then blended for 30 seconds. To the same blender, 5 g of 2.5M LiFSI in a nonaqueous solvent was added and blended for 30 seconds to form the active mixture. 5 g of the active mixture was added to a mortar at 80° C. and the active mixture was ground using a pestle for 10 minutes. The active mixture was then calendared multiple times to obtain a cathode file with a desired thickness (e.g., 140 μm for cathode A7 and 66 μm for cathode A8). The cathode film was laid on a carbon coated aluminum foil and fed through with rollers heated to 90° C. to laminate the film, complete the fabrication and obtain the cathode with cathode current collector. Each cathode includes the following formulation: 85.6 wt % NMC811, 2.7 wt % VGCF, 2.7 wt % LITX-HP, and 9 wt % 2.5M LiFSI in an electrolyte solvent.

### Preparation of Coin Cells

TABLE 3

| | | | Specific | 1^{st} |
|---|---|---|---|---|
| | | Areal | DisCharge | cycle |
| | Thickness | Capacity | Capacity | CE |
| Electrode | (μm) | (mAh/cm²) | (mAh/g) | (%) |
| Reference Electrode | 50 | 3.0 | 208 | 89.5 |
| A7 | 138 | 8.88 | 206 | 92.3 |
| A8 | 66 | 4.3 | 211 | 94.5 |

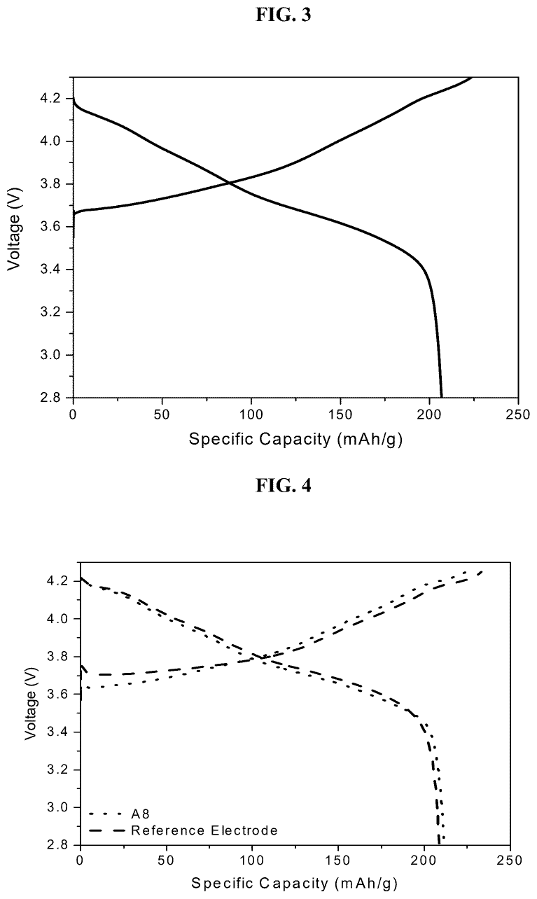

Each cathode A7 and A8, independently, was assembled in a 2032-coin cell with Li metal as anode. The cycling test was performed with a Neware cycling tester. All the batteries were tested using the same charging and discharging rate. The charge/discharge voltage window was from 2.8 V to 4.3 V. The battery was charged and discharged at a current rate of 0.1 C as formation and areal capacity is calculated based on the total capacity divided by the active area. In the cycling step, the battery was charged at C/3 and discharged at various C-rates up to 1 C. The reference electrode was prepared by mixing a NMC811 cathode, LITX-HP, and PVDF in a NMP solution. The mixture was then cast on the current collector. The coated film was then dried to remove the NMP and calendared. The final cathode formulation is 94% NMC811, 3% LITX-HP, and 3% PVDF with the loading of 3.0 mAh/cm². Table 3 shows the results of the battery testing. FIG. 3 shows the testing results of the battery with the A7 electrode and FIG. 4 shows the testing results of the battery with the A8 electrode. All electrodes including the reference electrode were tested under the same condition including the same soaking time. Compared to the preparation and performance of the reference electrode, the methods disclosed herein, e.g., methods of preparing electrodes A7 and A8, can improve the battery formation and result in a higher 1^{st} cycle Coulombic efficiency. As used herein, the term “Coulombic efficiency” (CE) refers to the result of discharge capacity divided by the charge capacity in the same charge and discharge cycle. In comparison with the cell with the reference electrode, the 1^{st} cycle CE of the cell with A7 and A8 was increased by 3.13% and 5.88%, respectively, which was unexpected.

### Aspects

In a first aspect of the present disclosure, a method of preparing an electrode comprises:
combining an electroactive material, an electron conductive material, an electrolyte comprising a salt and a nonaqueous solvent, and a polymeric binder to form an active mixture; and
shaping the active mixture to form an electrode,
   wherein the salt is present in an amount of about 5 wt % to about 75 wt % based on the total weight of the electrolyte, and the electroactive material, the electron conductive material, the electrolyte and the polymeric binder are present in an amount in a range from about 50 wt % to about 98.8 wt %, from about 0.1 wt % to about 10 wt %, from about 1 wt % to about 30 wt % and from about 0.1 wt % to about 10 wt % based on the total weight of the electrode, respectively. In some embodiments, the electrode can be cathode or anode.

In a second aspect according to the first aspect, the method further comprises heating the active mixture prior to the shaping, during the shaping, or both.

In a third aspect according to the first or second aspect, an electroactive material, an electron conductive material and a polymeric binder are first combined into an intermediate mixture followed by combining with an electrolyte to form the active mixture.

In a fourth aspect according to the first or second aspect, the electrolyte is present in an amount of no higher than 15.0 wt % based on the total weight of the active mixture or the electrode.

In a fifth aspect according to the first or second aspect, the nonaqueous solvent of the salt dissolves the salt and does not dissolve the polymeric binder.

In a sixth aspect according to the first or second aspect, the method does not include a drying step and the nonaqueous solvent remains in the active mixture and the electrode.

In a seventh aspect according to the first or second aspect, the nonaqueous solvent is substantially free of N-methyl-2-pyrrolidone (NMP), dimethylformamide (DMF), dimethylacetamide (DMAc), and dimethylsulfoxide (DMSO).

In an eighth aspect according to the first or second aspect, the active mixture is shaped by calendaring to form the electrode.

In a nineth aspect according to the first or second aspect, the electrode has an areal capacity of at least 2 mAh/cm² and a thickness of at least 30 μm.

In a tenth aspect according to the nineth aspect, the electrode has a thickness in a range from about 50 μm to about 170 μm, and an areal capacity in a range from about 2 mAh/cm² to about 15 mAh/cm². In some embodiments, the electrode has a thickness of about 30 μm to about 200 μm, about 50 μm to about 170 μm, or about 60 μm to about 160 μm, and an areal capacity of about 2 mAh/cm² to about 15 mAh/cm², about 3.5 mAh/cm² to about 15 mAh/cm², about 4 mAh/cm² to about 10 mAh/cm², or about 5.5 mAh/cm² to about 10 mAh/cm².

In an eleventh aspect according to the first or second aspect, the polymeric binder is a fibrillizable binder. In some embodiments, the polymeric binder is present in an amount of about 0.1 wt % to about 10 wt %, about 0.5 wt % to about 5 wt %, or about 0.5 wt % to about 2.5 wt %, based on the total weight of the electrode.

In a twelfth aspect according to the first or second aspect, the polymeric binder comprises a fluorinated polymer.

In a thirteenth aspect according to the twelfth aspect, the fluorinated polymer comprises at least one selected from the group consisting of polytetrafluoroethylene (PTFE), polyvinylidene fluoride (PVDF), poly(vinylidene fluoride-co-hexafluoropropylene) (PVDF-HFP), polyvinylfluoride (PVF), perfluoroalkoxy polymer (PFA), and fluorinated ethylene-propylene (FEP).

In a fourteenth aspect according to the first aspect, the electron conductive material is a conductive carbon. In some embodiments, the electron conductive material is present in an amount of about 0.1 wt % to about 10 wt %, about 0.5 wt % to about 5 wt %, or about 0.5 wt % to about 3.5 wt %, or about 1.5 wt % to about 3.5 wt %, based on the total weight of the active mixture or electrode.

In a fifteenth aspect according to any preceding aspect, the electroactive material comprises one or more of LiFePO₄, LiₓMO₂, LiₓNi_{1-y-z}Co_{y}M1_{z}O₂ and LiₓNi_{1-y-z}Mn_{y}M2_{z}O₂, wherein M is at least one selected from the group consisting of Ni, Co, Mn, Al, B, Fe, Mg, Ca, Sr, Sc, Y, Ti, Zr, V, Nb, Ta, Cr, Mo, W, Rh, Pd, Cu, Zn, Cd, Ga, In, Sn, and rare earth elements, wherein M1 is one or more selected from the group consisting of Mn, Al, B, Fe, Mg, Ca, Sr, Sc, Y, Ti, Zr, V, Nb, Ta, Cr, Mo, W, Rh, Pd, Cu, Zn, Cd, Ga, In, Sn, and rare earth elements, wherein M2 is one or more selected from the group consisting of Co, Al, B, Fe, Mg, Ca, Sr, Sc, Y, Ti, Zr, V, Nb, Ta, Cr, Mo, W, Rh, Pd, Cu, Zn, Cd, Ga, In, Sn, and rare earth elements, and wherein 0.95≤x≤1.1, 1-y-z>0, 0<y≤0.5, 0≤z<0.5. In some embodiments, the electroactive material is present in an amount of about 50 wt % to about 98.8 wt %, or about 60 wt % to about 97 wt %, or about 75 wt % to about 95 wt %, or about 85 wt % to about 98 wt %, based on the total weight of the active mixture or electrode.

In a sixteenth aspect according to any preceding aspect, the salt comprises one or more selected from the group consisting of lithium perchlorate (LiClO₄), lithium hexafluorophosphate (LiPF₆), lithiumborofluoride (LiBF₄), lithium hexafluoroarsenide (LiAsF₆), lithium trifluoro-metasulfonate (LiCF₃SO₃), lithium bis(trifluoromethanesulfonyl)imide (LiN(CF₃SO₂)₂, LiTFSI), lithium bis(oxalato)borate (LiBOB), lithium oxalyldifluoroborate (LiBF₂C₂O₄), lithium nitrate (LiNO₃), lithium fluoroalkylphosphates (Li[PFₓ(C_{y}F_{2y+1-z}H_{z})₆₋ₓ]) (1≤x≤5, 1≤y≤8, and 0≤z≤2y−1), lithium bisperfluoroethysulfonylimide (LiBETI), lithium bis(fluorosulphonyl)imide, lithium difluoro(oxalato)borate (LiDFOB), lithium fluorophosphate (Li₂PO₃F), lithium difluoro (bisoxalato)phosphate (LiC₇PO₈F₂), lithium tetrafluoro oxalato phosphate (LiC₂PO₄F₄), lithium difluorophosphate (LiDFP), LiC(CF₃SO₂)₃, LiF, LiCl, LiBr, LiI, Li₂SO₄, Li₃PO₄, Li₂CO₃, LiOH, lithium acetate, lithium trifluoromethyl acetate, and lithium oxalate. In some embodiments, the salt is present in an amount of about 5 wt % to about 75 wt %, or about 15 wt % to about 75 wt %, or about 25 wt % to about 75 wt %, or about 30 wt % to about 70 wt %, or about 40 wt % to about 60 wt %, or about 15 wt % to about 50 wt %, based on the total weight of the electrolyte

In a seventeenth aspect according to any preceding aspect, the nonaqueous solvent comprises at least one selected from the group consisting of 1,2-diethoxyethane, 1,1-diethoxyethane, 1,1-dipropoxy-ethane, 1,2-dipropoxy-ethane, diethylene glycol, 2-(2-ethoxyethoxy) ethanol, diethylene glycol dimethyl ether, diethylene glycol diethyl ether, diethylene glycol dibutyl ether, triethylene glycol, tri (ethylene glycol) monomethyl ether, tri (ethylene glycol) monoethyl ether, tri (ethylene glycol) monobutyl ether, triethylene glycol dimethyl ether, triethylene glycol diethyl ether, diethylene glycol dibutyl ether, tetraethylene glycol, tetra(ethylene glycol) monomethyl ether, tetra(ethylene glycol) monoethyl ether, tetra(ethylene glycol) monobutyl ether, tetraethylene glycol dimethyl ether, tetraethylene glycol diethyl ether, tetraethylene glycol dibutyl ether, ethylene carbonate, diethyle carbonate, dimethyl carbonate, ethyl methyl carbonate, propylene carbonate, fluoroethylene carbonate, vinylene carbonate, succinonitrile, succinonitrile, glutaronitrile, hexonitrile, malononitrile, dimethyl sulfoxide, prop-1-ene-1,3-sultone, sulfolane, ethyl vinyl sulfone, tetramethylene sulfone, vinyl sulfone, methyl vinyl sulfone, phenyl vinyl sulfone, N-propyl-N-methylpyrrolidinium bis(fluorosulfonyl)imide, 1-ethyl-3-methylimidazolium bis(fluorosulfonyl)imide, trimethyl phosphate, triethyl phosphate, and poly(ethylene oxide).

In an eighteenth aspect, the present disclosure provides an electrochemical device comprising the electrode as prepared by the methods according to any preceding aspect. In some embodiments, the electrochemical device further comprises an anode, wherein the anode is a carbon anode, Li anode, Si anode, alloy anode, Li₄Ti₅O₁₂, or made from conversion anode materials.

In a nineteenth aspect according to the eighteenth aspect, the electrode has a thickness of in a range from about 50 μm to about 200 μm.

In a twentieth aspect according to the eighteenth aspect, the electrode has a thickness of at least 80 μm and has an areal capacity of at least 5 mAh/cm².

All transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Various embodiments of the features of this disclosure are described herein. However, it should be understood that such embodiments are provided merely by way of example, and numerous variations, changes, and substitutions can occur to those skilled in the art without departing from the scope of this disclosure. It should also be understood that various alternatives to the specific embodiments described herein are also within the scope of this disclosure.

We claim:

1. A method of preparing an electrode, the method comprising:
combining an electroactive material, an electron conductive material, an electrolyte comprising a salt and a nonaqueous solvent, and a polymeric binder to form an active mixture; and
shaping the active mixture to form an electrode,
wherein:
the salt is present in an amount of about 5 wt % to about 75 wt % based on the total weight of the electrolyte, and
the electroactive material, the electron conductive material, the electrolyte and the polymeric binder are present in an amount in a range from about 50 wt % to about 98.8 wt %, from about 0.1 wt % to about 10 wt %, from about 1 wt % to about 30 wt % and from about 0.1 wt % to about 10 wt % based on the total weight of the electrode, respectively.

2. The method of claim 1, further comprising heating the active mixture prior to the shaping, during the shaping, or both.

3. The method of claim 1, wherein the electron conductive material, the polymeric binder and the electroactive material are first combined into an intermediate mixture followed by combining with the electrolyte to form the active mixture.

4. The method of claim 1, wherein the electrolyte is present in an amount of no higher than 15.0 wt % based on the total weight of the active mixture or the electrode.

5. The method of claim 1, wherein the nonaqueous solvent of the salt does not dissolve the polymeric binder.

6. The method of claim 1, wherein the method does not include a drying step and the nonaqueous solvent remains in the active mixture and the electrode.

7. The method of claim 1, wherein the nonaqueous solvent is substantially free of N-methyl-2-pyrrolidone (NMP), dimethylformamide (DMF), dimethylacetamide (DMAc), and dimethylsulfoxide (DMSO).

8. The method of claim 1 wherein the active mixture is shaped by calendaring to form the electrode.

9. The method of claim 1, wherein the electrode has an areal capacity of at least 2 mAh/cm² and a thickness of at least 30 μm.

10. The method of claim 9, wherein the electrode has a thickness in a range from about 50 μm to about 170 μm, and an areal capacity in a range from about 2 mAh/cm² to about 15 mAh/cm².

11. The method of claim 1, wherein the polymeric binder is a fibrillizable binder.

12. The method of claim 1, wherein the polymeric binder comprises a fluorinated polymer.

13. The method of claim 12, wherein the fluorinated polymer comprises at least one selected from the group consisting of polytetrafluoroethylene (PTFE), polyvinylidene fluoride (PVDF), poly(vinylidene fluoride-co-hexafluoropropylene) (PVDF-HFP), polyvinylfluoride (PVF), perfluoroalkoxy polymer (PFA), and fluorinated ethylene-propylene (FEP).

14. The method of claim 1, wherein the electron conductive material is a conductive carbon.

15. The method of claim 1, wherein the electroactive material comprises one or more selected from the group consisting of LifePO₄, LiₓMO₂, LiₓNi_{1-y-z}Co_{y}M1_{z}O₂ and LiₓNi_{1-y-z}Mn_{y}M2_{z}O₂, wherein M is at least one selected from the group consisting of Ni, Co, Mn, Al, B, Fe, Mg, Ca, Sr, Sc, Y, Ti, Zr, V, Nb, Ta, Cr, Mo, W, Rh, Pd, Cu, Zn, Cd, Ga, In, Sn, and rare earth elements, wherein M1 is one or more selected from the group consisting of Mn, Al, B, Fe, Mg, Ca, Sr, Sc, Y, Ti, Zr, V, Nb, Ta, Cr, Mo, W, Rh, Pd, Cu, Zn, Cd, Ga, In, Sn, and rare earth elements, wherein M2 is one or more selected from the group consisting of Co, Al, B, Fe, Mg, Ca, Sr, Sc, Y, Ti, Zr, V, Nb, Ta, Cr, Mo, W, Rh, Pd, Cu, Zn, Cd, Ga, In, Sn, and rare earth elements, and wherein 0.95≤x≤1.1, 1-y-z>0, 0<y≤0.5, 0≤z≤0.5.

16. The method of claim 1, wherein the salt comprises at least one selected from the group consisting of lithium perchlorate (LiClO₄), lithium hexafluorophosphate (LiPF₆), lithiumborofluoride (LiBF₄), lithium hexafluoroarsenide (LiAsF₆), lithium trifluoro-metasulfonate (LiCF₃SO₃), lithium bis(trifluoromethanesulfonyl)imide (LiN(CF₃SO₂)₂, LiTFSI), lithium bis(oxalato)borate (LiBOB), lithium oxalyldifluoroborate (LiBF₂C₂O₄), lithium nitrate (LiNO₃), lithium fluoroalkylphosphates (Li[PFₓ(C_{y}F_{2y+1-z}H_{z})₆₋ₓ]) (1≤x≤5, 1≤y≤8, and 0≤z≤2y−1), lithium bisperfluoroethysulfonylimide (LiBETI), lithium bis(fluorosulphonyl)imide, lithium difluoro(oxalato)borate (LiDFOB), lithium fluorophosphate (Li₂PO₃F), lithium difluoro (bisoxalato)phosphate (LiC₄PO₈F₂), lithium tetrafluoro oxalato phosphate (LiC₂PO₄F₄), lithium difluorophosphate (LiDFP), LiC(CF₃SO₂)₃, LiF, LiCl, LiBr, LiI, Li₂SO₄, Li₃PO₄, Li₂CO₃, LiOH, lithium acetate, lithium trifluoromethyl acetate, and lithium oxalate.

17. The method of claim 1, wherein the nonaqueous solvent comprises one or more selected from the group consisting of 1,2-diethoxyethane, 1,1-diethoxyethane, 1,1-dipropoxy-ethane, 1,2-dipropoxy-ethane, diethylene glycol, 2-(2-ethoxyethoxy) ethanol, diethylene glycol dimethyl ether, diethylene glycol diethyl ether, diethylene glycol dibutyl ether, triethylene glycol, tri(ethylene glycol) monomethyl ether, tri (ethylene glycol) monoethyl ether, tri (ethylene glycol) monobutyl ether, triethylene glycol dimethyl ether, triethylene glycol diethyl ether, diethylene glycol dibutyl ether, tetraethylene glycol, tetra(ethylene glycol) monomethyl ether, tetra(ethylene glycol) monoethyl ether, tetra(ethylene glycol) monobutyl ether, tetraethylene glycol dimethyl ether, tetraethylene glycol diethyl ether, tetraethylene glycol dibutyl ether, ethylene carbonate, diethyle carbonate, dimethyl carbonate, ethyl methyl carbonate, propylene carbonate, fluoroethylene carbonate, vinylene carbonate, succinonitrile, succinonitrile, glutaronitrile, hexonitrile, malononitrile, dimethyl sulfoxide, prop-1-ene-1,3-sultone, sulfolane, ethyl vinyl sulfone, tetramethylene sulfone, vinyl sulfone, methyl vinyl sulfone, phenyl vinyl sulfone, N-propyl-N-methylpyrrolidinium bis(fluorosulfonyl)imide, 1-ethyl-3-methylimidazolium bis(fluorosulfonyl)imide, trimethyl phosphate, triethyl phosphate, and poly(ethylene oxide).

18. An electrochemical device comprising the electrode as prepared by the method of claim 1.

19. The electrochemical device of claim 18, wherein the electrode has a thickness of in a range from about 50 μm to about 200 μm.

20. The electrochemical device of claim 18, wherein the electrode has a thickness of at least 80 μm and has an areal capacity of at least 5 mAh/cm².
